(19) United States
(12) Patent Application Publication
(10) Pub. No.: US 2023/0365010 A1
(43) Pub. Date: Nov. 16, 2023

(54) BIDIRECTIONAL PORTABLE EV CHARGING CABLE

(71) Applicant: HagerEnergy GmbH, Osnabrück (DE)

(72) Inventors: Andreas PIEPENBRINK, Osnabrück (DE); Nicolai LESCOW, Osnabrück (DE)

(21) Appl. No.: 18/195,433

(22) Filed: May 10, 2023

(30) Foreign Application Priority Data
May 10, 2022 (DE) 10 2022 111 567.4

(51) Int. Cl. B60L 53/18

(52) U.S. Cl. CPC B60L 53/18

(57) ABSTRACT

A single-phase charging cable for an electric vehicle includes a single-phase mains plug including a charging plug, which can be locked in the electric vehicle, and charging electronics arranged electrically between the mains plug and the charging plug. The charging electronics include a bidirectional AC/DC converter and at least one bidirectional DC/DC converter.

### CROSS REFERENCE TO RELATED APPLICATIONS

This application claims the benefit of priority to German Patent Application No. 10 2022 111 567.4 filed on May 10, 2022. The entire contents of this application are hereby incorporated herein by reference.

### BACKGROUND OF THE INVENTION

### 1. Field of the Invention

The present invention relates to a charging cable, a charging device for an electric motor vehicle, and a mobile power supply.

### 2. Description of the Related Art

So-called wallboxes for charging electrically powered vehicles are often installed at private charging stations on residential buildings, in garages, or in underground parking garages. These wallboxes are connected to the public low-voltage grid in three phases. They provide a charging power in the range of about 11 kilowatts (kW) to 22 kW. To feed electrical energy from the motor vehicle into the public grid or into a buffer battery available in the building, a wallbox can optionally also be designed bidirectionally. The power taken from the vehicle accumulator is usually greater than 2.5 kW, since at lower discharge powers the efficiency of the electrical conversion from the DC voltage present in the vehicle to the AC voltage of the low-voltage grid would otherwise drop significantly. For reasons of efficiency, charging of the motor vehicle is also generally not started until a power of around 4.5 kW is available.

The electrical power flowing within this known solution is much greater than the average power demand of a household or a single-family home. The minimum charging power required in three-phase operation is also greater in many cases than the power usually available from a domestic photovoltaic system. The wallboxes are designed to be wall-mounted. The power electronics contained therein are complex and correspondingly expensive, just as the installation effort for connecting such a wallbox to the three-phase low-voltage grid is relatively large. The same applies vice versa to installations which are connected to split-phase systems in those countries where these are commonly available.

Also known from the prior art are so-called emergency charging cables, which have a non-lockable single-phase mains plug and a unidirectional AC/DC converter. These charging cables are portable, but only suitable for charging an electric vehicle at a household socket. In particular, it is not possible to feed electric energy from the electric vehicle into the low-voltage grid.

### SUMMARY OF THE INVENTION

Preferred embodiments of the present invention provide portable charging devices for electric motor vehicles that each require less installation effort, is less expensive, and operates at lower power levels.

Because in a single-phase charging cable for an electric vehicle, with a single-phase mains plug, with a charging plug which can be locked in the electric vehicle and with charging electronics which are electrically arranged between the mains plug and the charging plug, it is additionally provided that the charging electronics include a bidirectional AC/DC converter and at least one bidirectional DC/DC converter, in addition to charging the vehicle, it is also possible to safely discharge the battery of the vehicle. In particular, the battery can also be used for grid support in accordance with the German guideline VDE AR 4105 or other equivalent guidelines, in that the device feeds in electrical power or provides reactive power.

Preferably, the charging electronics are housed in a housing connected to the vehicle-side cable and to the mains-side cable in a waterproof and dustproof manner. Physically, the device is preferably built as an in-cable controller or in-cable charger.

The charging cable can be used particularly safely if the power plug is a lockable power plug. This ensures that the electrical connection cannot be disconnected under load. Safety in accordance with German guideline DIN VDE 0100-551 or other equivalent guidelines is then guaranteed when using a corresponding lockable socket.

The charging cable is suitable for simple connection to a standard single-phase socket if the AC/DC converter is set up for connection to a low-voltage grid with one phase and a rated voltage of, depending on the layout of the grid, about 110 V to about 120 V or about 220 V to about 240 V. If the DC/DC converter is set up for connection to an electrically powered motor vehicle with a DC voltage of about 200 V to about 920 V, almost any vehicle battery can be charged with DC voltage on the connection side of the vehicle.

Preferably, the charging electronics include a communication interface for bidirectional communication with the motor vehicle, in particular with the battery management system of the motor vehicle. This means that the readiness for charging can be communicated on both sides, as can the result of an insulation test and the status of the charging and discharging management system. In a similarly advantageous manner, the charging electronics can include a communication interface for bidirectional communication with the mains connection. This improves the operational reliability, the control of charging and discharging and the mains grid support of the vehicle battery.

If in the charging cable, the AC/DC converter is connected to a first DC/DC converter, and the first DC/DC converter is connected to a second DC/DC converter, each of these components can be optimized for its particular purpose. Thus, weight savings can be achieved as well as optimization of the function of the entire device.

The first DC/DC converter provided in the charging electronics of the charging cable can be a galvanically non-isolating DC/DC converter with a variable voltage ratio between input voltage and output voltage of about 1:3 to about 1:5. This allows a wide voltage range to be provided on the secondary side, as may be encountered in practice for various vehicle batteries. There is a cost advantage if galvanic isolation can be dispensed with in this converter.

If further the second DC/DC converter is a galvanically isolating DC/DC converter with a voltage ratio between input voltage and output voltage of about 1:1 to about 1:2, this converter can be made small and inexpensive. Preferably, the second DC/DC converter is an LLC converter.

If, in the case of a charging device with a charging cable as described above, a single-phase socket is provided on the mains side which is connected to a final circuit, electrical safety in feed-in operation is also ensured. Then, in particular, emergency power operation for the building is also possible in the event of a power failure in the public grid. Preferably, the charging device has a mechanically or electrically lockable socket on the building side. This ensures electrical safety before connecting the charging cable to the low-voltage grid and when disconnecting the charging cable from the low-voltage grid at the power socket.

A new mobile power supply device is also provided, with a charging cable as described above and an adapter to which at least one single-phase socket is connected. With this power supply device, an electric vehicle can be used via the connected charging cable and adapter to provide “household power” for electric appliances from the vehicle's traction battery.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 shows a schematic topology of a charging cable for bidirectional, single-phase connection of an electric motor vehicle to a building-side low-voltage grid.

FIG. 2 shows the charging electronics of the charging cable in a more detailed illustration.

FIG. 3 shows another preferred embodiment of charging electronics of the charging cable.

FIG. 4 shows a schematic representation of the vehicle and the bidirectional charging cable when used as a power source via an adapter.

FIG. 5 shows charging electronics as shown in FIG. 2, which is designed for a single-phase three-wire grid on the mains side.

FIG. 6 shows another layout of charging electronics corresponding to FIG. 3, which is designed for a single-phase three-wire grid on the mains side.

### DETAILED DESCRIPTION OF THE PREFERRED EMBODIMENTS

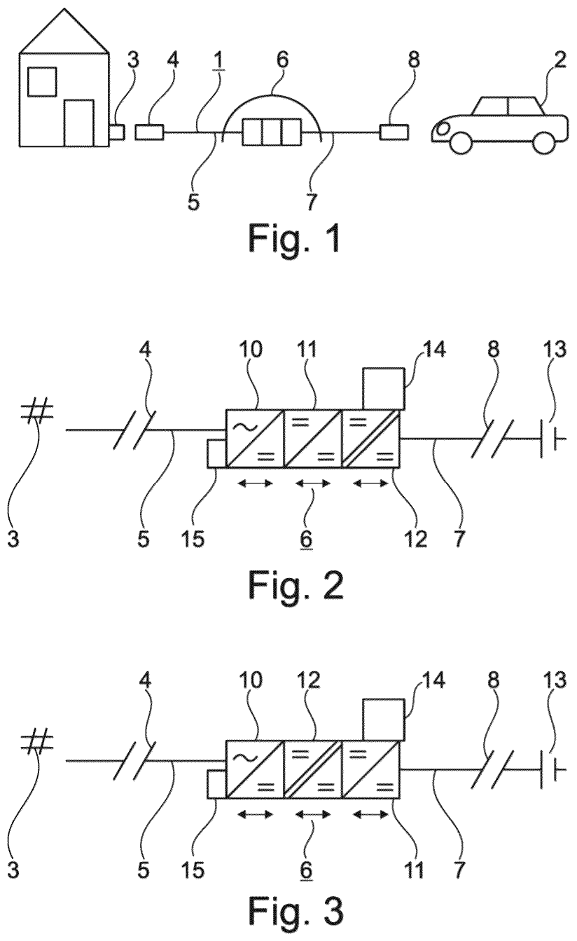

FIG. 1 shows a schematic topology of a charging cable 1 for bidirectional, single-phase connection of an electric motor vehicle 2 to a low-voltage grid 3 on the building side. It should be clarified here that a “single-phase connection” or a “single-phase grid” does not only mean the system commonly used in Europe with a phase fed from a three-phase grid and a neutral, but also the split-phase system or single-phase three-wire system commonly used in the USA, for example.

Viewed from the mains side towards the vehicle, the charging cable 1 includes a lockable mains plug 4, which is connected via a three-core cable 5 to charging electronics 6, which will be explained in more detail below. The charging electronics 6 is in turn connected to a cable 7 with a lockable plug 8, for example, a CCS plug.

The charging electronics 6 are shown in more detail in FIG. 2. It is designed as a module that is permanently and captively looped into the cable and can therefore be carried along in the vehicle together with the connecting cables 5 and 7. On the other hand, the charging electronics cannot be separated from the connecting cables 5 or 7 by a user. Such arrangements are referred to as “in-cable charger” or “in-cable controller”.

The charging electronics 6 include an AC/DC converter 10 which has a connection to the low-voltage mains, for example, about 120 V (Volt) 60 Hz (Hertz) or about 230 V 50 Hz, and a DC link voltage of, for example, about 350 V DC. The DC link is connected to a first DC/DC converter 11, which is designed as a DC voltage regulator and can set a voltage ratio of about 1:1 to about 1:5 in this example. Thus, on the output side, about 200 V to about 1,000 V DC can be applied to the first DC/DC converter 11. The output side of the first DC/DC converter is connected to an input of a second DC/DC converter 12. Unlike the first DC/DC converter 11, this second DC/DC converter 12 is galvanically isolating and has a voltage ratio of about 1:1. All components of the charging electronics 6 described to this extent are controlled and monitored by a controller 14 which is not shown in greater detail. This control 14 is preferably structurally integrated into the charging electronics 6 itself.

Thus, on the output side of the second DC/DC converter 12, an electrically isolated DC voltage of about 200 V to about 1,000 V is available when the charging cable is connected to the mains 3 and the controller 14 has selected and enabled the voltage. This allows the charging process for a battery 13 of the electric vehicle 2 to begin. The charging power is approximately in the range of about 1 kW to about 4 kW, depending on the power available in the grid 3. The charging power can be controlled via a wireless or wired communication interface 15, for example, by a building management system, by the battery charging management system, or even by the grid operator.

The AC/DC converter 10, the first DC/DC converter 11, and the second DC/DC converter 12 are bidirectional, for example. Therefore, the vehicle battery 13 can also be operated to serve the grid in accordance with the currently (2022) valid German application rule VDE AR 4105. Power from the battery 13 can be fed into the grid 3, for example, to supply the building during peak load periods. Reactive power can also be provided to stabilize the grid 3, in particular without active power flowing. If the building is suitably equipped, the vehicle battery can also provide an emergency power supply in the event of a grid power failure.

Another preferred embodiment of the present invention is shown in FIG. 3. This preferred embodiment differs from the one shown in FIG. 2 in that the second DC/DC converter 12 with the voltage ratio of about 1:1 is electrically arranged between the AC/DC converter 10 and the DC/DC converter 11. This topology has the advantage that the second DC/DC converter 12, when connected immediately after the AC/DC converter 10, are designed to have a relatively low DC link voltage of about 350V. This DC link voltage is relatively low in relation to the possible charging voltage for the vehicle of up to about 1,000 V. In particular, the second DC/DC converter 12 does not have to be designed for a wide voltage range.

Charging devices for electric motor vehicles usually require a minimum available charging power in order to be able to go into operation at all. The new topologies and arrangements described above require only a small minimum charging power and therefore have the advantage that this power level can also be generated by smaller photovoltaic systems that cannot or cannot always supply the minimum power for the operation of three-phase or split-phase charging devices.

The single-phase design of the charging cable 1 means that the transmitted power is limited to the above values. In many cases, however, higher powers are not required. However, it is particularly advantageous that, in contrast to three-phase or split-phase wallboxes, the charging cable can be used without fixed, complex installation and that it is transportable and portable, usually weighing less than about 5 kg, for example. The building-side installation is limited to a lockable single-phase socket connected to a final circuit. The charging cable 1 and especially the in-cable electronics 6 are easy to cool at the mentioned power rating and a possible efficiency of about 97%-about 98%, either passively via heat sinks or via the housing, or also via a built-in fan, which can be small in size. If for example the rated power is about 2 kW and the efficiency is about 98%, then the produced heat is about 40 W, which can be easily dissipated.

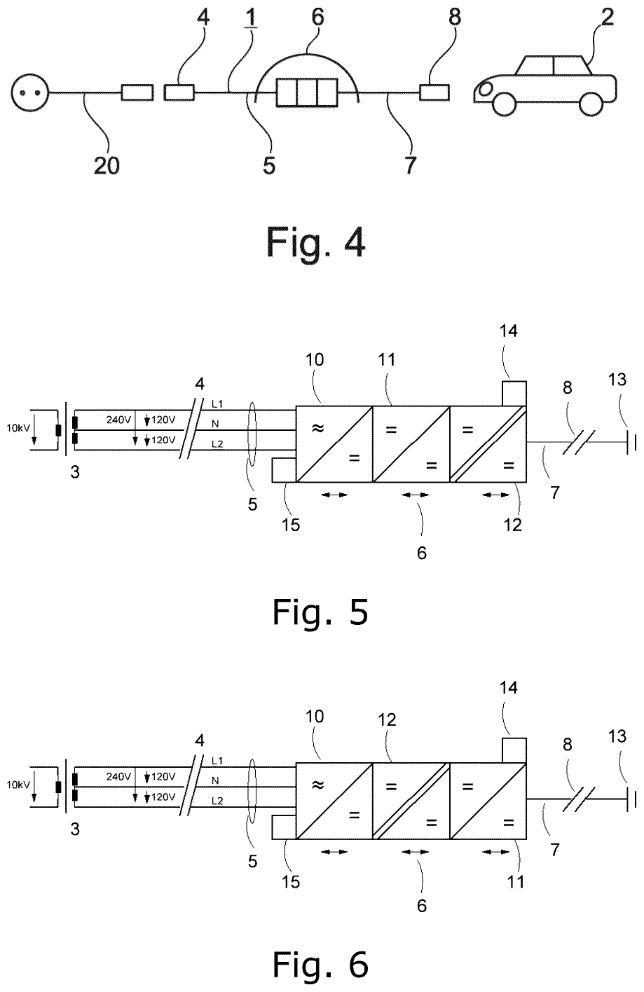

In another preferred embodiment of the present invention, the charging cable serves as a power source in conjunction with a connected vehicle. This is shown schematically in FIG. 4. An adapter 20 may, on the one hand, be connected to the mains plug 4 of the charging cable 1 and, on the other hand, have a conventional household socket or multiple socket in the manner of a cable drum. When the charging cable 1 is connected to the vehicle 2, the electronics 6 can communicate with the vehicle 2, which communication can be wireless or wired via the controller 14. If the connection is accepted, the discharge of the vehicle battery 13 is enabled. For this purpose, according to the currently applicable regulations, the charging cable 1 itself must provide a voltage at the connector 8. This can be generated from a voltage source present in the electronics 6, for example, in the form of a dry battery. It may also be provided that the electronics 6 have an external input for this purpose, for example, for an approximately 12 V voltage source. When the vehicle 2 has enabled discharge, a standard household voltage of, for example, about 230 V 50 Hz can be provided via the charging cable 1 at the connector 4 and the adapter 20 connected thereto. The intended power at this connection is then, for example, about 2 kW, which corresponds to the power of a common portable power generator.

FIG. 5 shows a topology corresponding to FIG. 2 described above, except that the AC side of the bidirectional AC/DC converter 10 is set up for connection to a single-phase three-wire grid as a low-voltage grid 3. Here, the cable 5 for connection to the mains includes three conductors, designated as L1, L2 and N. The conductor L1 carries an alternating voltage of, for example, about 120 volts with respect to conductor N. The conductor L2 carries an alternating voltage of, for example, about 120 volts with respect to conductor N. However, the phases of the AC voltages in L1 and L2 are shifted by about 180°, resulting in an AC voltage of about 240 volts between L1 and L2. This system is common in North America and other countries.

FIG. 6 shows an arrangement like FIG. 5, but with the topology of FIG. 3. The same advantages arise here as described for FIG. 3 above.

The use of the arrangement of FIG. 5 and FIG. 6 to supply a building grid in emergency power operation, in which the charging cable serves as a power source in conjunction with a connected vehicle, is also possible as shown in FIG. 4. In this case, preferably only AC voltage on one of the conductors L1 or L2 with respect to the neutral conductor N is then made available to the building on the AC voltage side of the AC/DC converter 10, as required, so that an AC voltage of, for example, about 120 volts is available. However, AC voltage can also be made available on L1 and L2 with the phases on the conductors being shifted by about 180° to each other. Then both approximately 120 volts and approximately 240 volts are available.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A single-phase charging cable for an electric vehicle, the single-phase charging cable comprising:
a single-phase mains plug including a charging plug which can be locked in the electric vehicle, and including charging electronics arranged electrically between the mains plug and the charging plug; wherein
the charging electronics include a bidirectional AC/DC converter and at least one bidirectional DC/DC converter.

2. The single-phase charging cable according to claim 1, wherein the charging electronics are housed in a housing connected to a vehicle-side cable and to a mains-side cable in a waterproof and dustproof manner.

3. The single-phase charging cable according to claim 1, wherein the power plug is a lockable power plug.

4. The single-phase charging cable according to claim 1, wherein the bidirectional AC/DC converter is connectable to a low-voltage grid with one phase and a nominal voltage of about 220 V to about 240 V or to a single-phase three-wire grid and a nominal voltage of about 120 V or about 240 V, respectively.

5. The single-phase charging cable according to claim 1, wherein the at least one bidirectional DC/DC converter is connectable to an electrically operated motor vehicle with a DC voltage of about 200 V to about 920 V.

6. The single-phase charging cable according to claim 5, wherein the charging electronics include a communication interface for bidirectional communication a battery management system of the electrically operated motor vehicle.

7. The single-phase charging cable according to claim 1, wherein the charging electronics include a communication interface for bidirectional communication with a mains connection.

8. The single-phase charging cable according to claim 1, wherein the bidirectional AC/DC converter is connected to a first DC/DC converter, and the first DC/DC converter is connected to a second DC/DC converter.

9. The single-phase charging cable according to claim 8, wherein the first DC/DC converter is a galvanically non-isolating DC/DC converter with a variable voltage ratio between input voltage and output voltage of about 1:3 to about 1:5.

10. The single-phase charging cable according to claim 8, wherein the second DC/DC converter is a galvanically isolating DC/DC converter with a voltage ratio between input voltage and output voltage of about 1:1 to about 1:2.

11. The single-phase charging cable according to claim 1, wherein the second DC/DC converter is an LLC converter.

12. A charging device comprising:
the single-phase charging cable according to claim 1; and
a single-phase socket connected to a terminal circuit.

13. The charging device according to claim 12, wherein the single-phase socket is a mechanically or electrically lockable socket.

14. A mobile power supply device comprising:
the single-phase charging cable according to claim 1; and
an adapter to which at least one single-phase socket is connected.
